(19) United States
(12) Patent Application Publication
(10) Pub. No.: US 2017/0323503 A1
(43) Pub. Date: Nov. 9, 2017

(54) Secure Phone Storage with Selective Transmission Functionality

(71) Applicant: Jorge E. Garcia, Redondo Beach, CA (US)

(72) Inventor: Jorge E. Garcia, Redondo Beach, CA (US)

(21) Appl. No.: 15/591,020

(22) Filed: May 9, 2017

Related U.S. Application Data
(60) Provisional application No. 62/333,752, filed on May 9, 2016.

(51) Int. Cl. G07C 9/00; H04W 4/12

(52) U.S. Cl. CPC G07C 9/00309; G07C 9/00912; H04W 4/12

(57) ABSTRACT

A secure mobile phone storage and wristband dispensing kiosk includes a support portion and a locker portion. The locker portion includes a plurality of storage compartments and a plurality of dispensing compartments. An authenticator is provided for authenticating the user of an individual storage compartment and dispensing compartment. A series of electronic wristbands are individually stored in each dispensing compartment. A processor is configured to condition unlocking a dispensing compartment upon successful connection of a mobile phone to a charging station in a storage compartment, and to condition unlocking a storage compartment upon successful authentication and installation of one of the electronic wristbands in a storage compartment, thereby allowing a user to store and charge a mobile phone while wearing a wristband that can receive rudimentary communications from the phone.

### CROSS-REFERENCE TO RELATED APPLICATION

This application claims the benefit of the priority filing date of U.S. provisional app. No. 62/333,752, filed May 9, 2016, which is incorporated herein in its entirety.

### BACKGROUND

The present invention generally relates to cellular phone storage. More specifically, the present invention relates to a cellular phone storage apparatus having dispensing capability for transmitting messages and alerts to devices dispensed while phones are stored.

### RELATED ART

Cell phones, and in particular smart phones, are in virtually universal use, including at work locations and during work hours. Smart phones have functionality going beyond traditional talk and text modes, and include the ability to give users ‘push notifications’ from various in-phone applications, such as news alerts and social networking messages. The prevalence of an increasing number of notifications represents increased disruptions during work time resulting in lowered productivity and an increased likelihood of injury on the job.

Many employers use employee lockers for storing employees' cell phones as a solution to lost productivity and increased likelihood of injury. Forcing employees to relinquish their phones completely removing an employee's phone completely can result in poor employee morale and attrition of workers an employer would otherwise seek to retain. Additionally, employees must feel comfortable leaving one of their most important possessions in the hands of the employer at a remote location. For this reason many employers simply allow employees to retain their cell phone and supervise the employee while on the job. This process is time consuming and employers having multiple employees may have a difficult time policing a worksite.

Hence, what is needed is a storage apparatus that allows employees to securely store their cell phones, while allowing basic communications, defined by the employer, between the employee and the employee's cell phone.

### SUMMARY

Disclosed is a secure phone storage with selective transmission functionality, which is designed to be installed at workplaces where an employer determines that smart phones create too much of a distraction for employees and wish to manage or mitigate the problem of confiscating employees smart phones which denies all types of external communication to the employees. The secure phone storage with alert mechanism locks away smart phones during working hours in a secure, highly-visible, and resilient manner that can only be accessed by the phone's owner using authentication. The key difference between the present apparatus and an ordinary secure locker is that the secure phone storage with alert mechanism is a computer controlled apparatus that automatically (and securely) exchanges physical smart phones for assigned smart bands or smart watches that allow employees to receive basic communications throughout the day even though the employees' smart phones are locked up hundreds of feet away.

The secure phone storage with alert mechanism includes a charging and data connection functionality designed for continued operation in cooperation with software installed on employees' smart phones. Communication is maintained with all stored smart phones, routing notifications of a predetermined type to the employees' individual smart watches in real-time, preferably using a radio wave-based signal. Other connectivity, such as wireless (WiFi) or BLUETOOTH® connectivity is also contemplated. The signal produced by the apparatus is preferably an encrypted data packet communication to promote ease of use and range. The nature of the communications and notifications transmitted between each smart phone its associated smart watch is envisioned as only being conventional text messages and missed calls, while employer-level application controls may be included to add notifications for other smart phone functionality such as emails or emergency news alerts.

When an employee is wearing the smart watch, with the employee's smart phone locked away, the employee will be able to silence the smart watch manually, but preferably will not be able to unilaterally decide which type of notifications are relayed by the apparatus. For example, when a text message is transmitted to the smart watch, the employee will be presented with the option of responding with a limited set of pre-programmed replies (between ten and twelve in contemplated embodiments) that the apparatus will be able to receive, relay and send as a reply or to a predetermined contact using the smart phone app connection.

Retrieving an employee's smart phone from its compartment is contingent upon the safe return and placement, and proper connection, of the smart watch in its corresponding compartment. In instances where the smart phone must be retrieved without the presence of the smart watch, it is anticipated the apparatus will have features to make an employer aware (via physical displays, lights, or data transmittal schemes) of the missing smart watch, such that the employer can hold an employee responsible for the cost of replacing the smart watch. The concept of spare bands, and the method in which they are managed, will be part-and-parcel of this product system. One important application contemplated for the apparatus is use in educational facilities, where students are preferably not to be distracted by their smart phones. The apparatus may also be integrated into other, larger types of storage lockers as necessary. One example is a fireman's locker, which provides room for a helmet, gear (fire retardant clothing, boots, etc.) and including a mobile phone/wristband exchange area.

In a specific embodiment, a secure mobile phone storage and wristband dispensing kiosk apparatus is disclosed for securely storing mobile phones while an electronic wristband is issued. The apparatus includes a support portion supporting and preferably coupled to a locker portion. The locker portion includes a plurality of storage compartments, a plurality of dispensing compartments and at least one authenticator, the authenticator capable of association with any individual storage compartment and dispensing compartment.

Each of the plurality of storage compartments includes a connector for a mobile phone, preferably also functioning as a charging station. A plurality of electronic wristbands are individually stored in each of the plurality of dispensing compartments. The electronic wristbands are wirelessly in communication with the apparatus, and preferably include a screen capable of displaying at least text communications.

A processor is in communication with the locker portion. The processor is configured to condition unlocking a dispensing compartment upon successful connection of a mobile phone to a charging station. Secondarily, the processor is configured to condition unlocking a storage compartment upon successful authentication by the at least one authenticator and installation of one of the plurality of electronic wristbands in one of the plurality of the storage compartments.

In various alternative embodiments, the support portion may be a vertical tower supporting the locker portion. Such a vertical tower preferably includes a widened base having a securing mechanism, thus preventing the apparatus from being easily removed from a location. Preferably the locker portion comprises a cylindrical shape, thus allowing users to approach and interact with the apparatus from any angle. For added ease of use, each of the plurality of storage compartments may be located adjacent an associated dispensing compartment, and each of the plurality of dispensing compartments may be located underneath an individual storage compartment. Preferably, the locker portion has between twenty and forty storage compartments and a corresponding number of dispensing compartments.

In other embodiments, the support portion or tower may include a solar array configured to recharge stored mobile phones, and the support portion, or another part of the apparatus may include a GPS transponder to report the location of the apparatus if moved. Preferably the charging station in each storage compartment includes a universal mobile phone connector for connecting to a variety of mobile phone brands, and each of the dispensing compartments may include a connector post for holding and charging a wristband.

The apparatus may also be characterized as a secure mobile phone storage and wristband dispensing kiosk apparatus having a support portion coupled to a locker portion, the locker portion comprising a plurality of storage compartments, a plurality of dispensing compartments and at least one authenticator, with each of the plurality of storage compartments comprising a mobile phone charging station, a plurality of electronic wristbands individually stored in each of the plurality of dispensing compartments, and at least one camera arranged to have a three hundred and sixty five degree view of an area surrounding the locker portion.

Similar to the primary embodiment, a processor is in communication with the locker portion, wherein the processor is configured to condition unlocking a dispensing compartment upon successful connection of a mobile phone to a charging station and configured to condition unlocking a storage compartment upon successful authentication by the at least one authenticator and installation of one of the plurality of electronic wristbands in one of the plurality of the storage compartments. In this embodiment, the authenticator may be a fingerprint scanner. Preferably the processor is configured to issue a single power outage warning collectively to the plurality of wristbands and is also configured to issue a low battery power warning independently to each of the plurality of wristbands.

Along with the apparatus itself, a method is disclosed for securely storing mobile phones, for example at a workplace where phones are not permitted, and issuing electronic wristbands in exchange for stored mobile phones. The method includes the steps of providing a locker portion of a mobile phone storage apparatus, providing a storage compartment within the locker, providing a dispensing compartment within the locker, activating an authentication process by interacting with the authenticator, unlocking a storage compartment, opening the storage compartment and connecting a mobile phone to a connector in the storage compartment, closing the storage compartment, and unlocking a dispensing compartment, opening the dispensing compartment and removing an electronic wristband.

The method preferably also includes the steps of transmitting a message received by the mobile phone to the electronic wristband, providing an authenticator associated with the storage compartment and the dispensing compartment, and unlocking the storage compartment upon authentication and the dispensing compartment receiving the wristband. The apparatus and method are more fully explained in the following detailed description and drawings.

### BRIEF DESCRIPTION OF THE FIGURES

FIG. 1 illustrates a secure phone storage with selective transmission functionality holding a cell phone;

FIG. 2 illustrates a cut-away view of the locker portion of the secure phone storage with selective transmission functionality;

FIGS. 3 and 4 illustrate a bottom perspective view and a side elevation view, respectively, of a cable and connector of the secure phone storage, including an interchangeable connector.

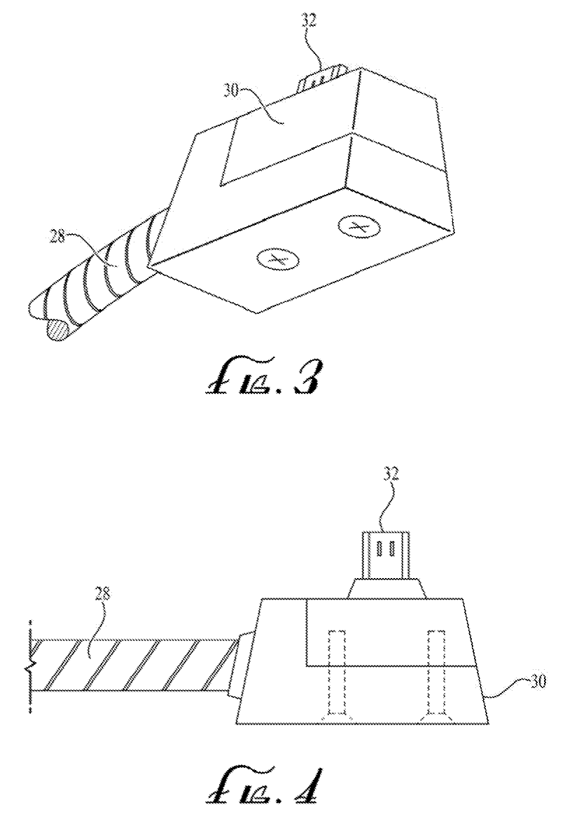

### DETAILED DESCRIPTION

The following description is presented to enable any person skilled in the art to make and use the invention, and is provided n the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

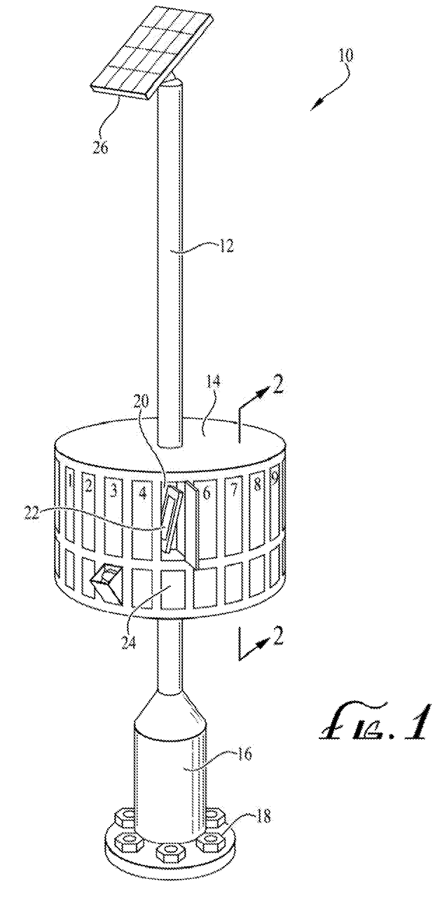

Referring to FIG. 1, the secure phone storage with alert mechanism is preferably configured as a storage kiosk 10 for housing cell phones 12. The storage kiosk 10 comprises a tower portion 12 and a locker portion 14 installed on the tower portion 12. In one preferred embodiment, the tower portion 12 comprises a pole, and is installed in a highly visible location. The tower portion 12 optimally has a widened base 16 which may be inserted directly into the ground, or secured to an anchorage (not shown) using bolts 18, or a similar securing mechanism. The base 16 or the entire tower portion 12 may be filled with concrete (not shown) at the time of construction, or on-site during installation to provide extra security by adding weight to the tower portion 12.

Although the locker portion 14 attached to the tower portion 12 can be built and arranged in many shapes and configurations, such as a single-sided rectangle similar to a vending machine, or even a series of one or two-sided bridge-like structures spanning several storage kiosks 10. For maximum usability and visibility, the illustrated embodiment shows a locker portion 14 having a carousel or drum shape, preferably between twenty four and fifty four inches in diameter, which is permanently attached to the tower portion 12.

The locker portion 14 comprises a plurality of storage compartments 20 in which a plurality of cell phones 22 may be individually stored. A plurality of dispensing compartments 24 are also stored on the locker portion 14, preferably with each dispensing compartment 20 associated with a storage compartment 16. In the illustrated embodiment, individual dispensing compartments 20 are located underneath individual storage compartments 16. With the locker portion 14 in a cylindrical ‘drum’ configuration, persons can easily access individual storage compartments 16.

Each phone storage compartment 20 represents a fractional “slice” of the overall locker portion 14. Given typical employee requirements, a preferred embodiment of the locker portion 14 includes between 20 and 40 storage compartments 20 and associated dispensing compartments 24. The number of storage compartments 20 and dispensing compartments 24 can be enlarged by increasing the diameter of the locker portion 14. The maximum diameter for the locker portion 14 is preferably about seventy two inches. For increased storage beyond that diameter, multiple storage kiosks 10 should be interconnected to support each other's weight.

Still referring to FIG. 1, the tower portion 12 may include a solar array 26 to assist with keeping stored cell phones 22 charged, and the storage compartments 20 are preferably numbered to help users identify the storage compartment 20 holding an individual cell phone 22. Additionally, the tower portion 12 may include GPS transponder functionality for added security and theft prevention.

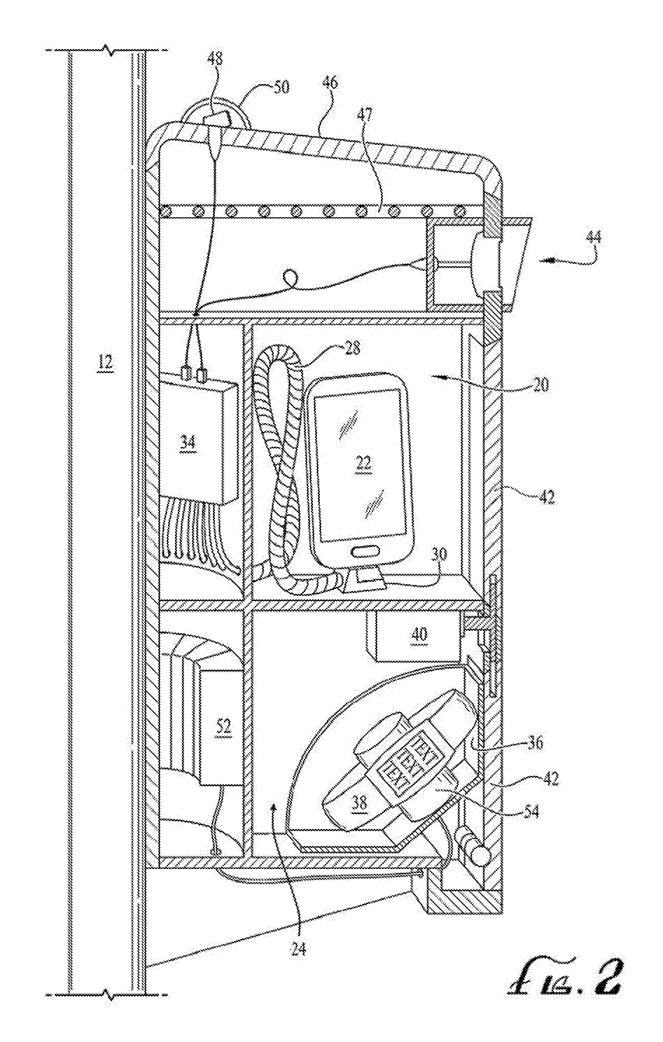

Referring to FIG. 2, inside each (numbered) storage compartment 20, there is a preferably very heavy-duty (i.e., armored) cable 28 which can be manually connected to each cell phone 22 via a charging station 30 attached to the cable 28. The charging station 30 includes a connector 32, which is ideally a universal connector 32 (i.e., having for example, micro-USB, USB-C, LIGHTENING® and similar functionality). In addition to providing the necessary data-link between the a central processing unit (CPU) 34 and each cell phone 22, the connector 32 supplies a charge (for example ‘trickle’ charging, i.e., charging under no-load at a rate equal to the self-discharge rate) to all cell phones 22 to avoid harm to any cell phone 22.

Immediately beneath each of the storage compartments 20, is a dispensing compartment 24. The dispensing compartments 24 each have a swing-out drawer 36 and safely store a multi-use smart watch 38. The drawer 36 preferably includes a post 54 for holding and, optionally, charging the smart watch 38. Although or a smart watch 38 is shown in the illustrated embodiment, any wearable communicating electronic device with a display, such as a smart bands, for example, is contemplated. A lock 40 allows a door 42 on the storage compartment 20, and the drawer 36 to open. Although a single lock 40 is shown in the illustrated embodiment, separate locks 40 for the door 42 and the drawer 36 are contemplated. The lock 40 is mechanically actuated and operated by the CPU 34.

Above each pair of storage compartment 20 and dispensing compartment 24 is an authenticator 44. The authenticator 44 is used to confirm the identity of the owner of the cell phone 22 stored in the storage compartment 20. In the illustrated embodiment the authenticator 44 comprises a fingerprint scanner or keypad accessible by a user. The authenticator 44 can include various authentication mechanisms including sensors, keypads, microphones, cameras, etc. Preferably a plurality of individually replaceable authenticators 44 are used, to allow ease of repair.

Above the authenticators 44 is the lid 46 of the locker portion 14. In order to allow radio waves to flow freely in and out of the locker portion 14, the lid 46 is preferably constructed of heavy duty acrylic or a similar non-interfering material suitable for radio waves. To discourage vandalism is theft, a protective mesh 47 is located immediately beneath the lid 46. The protective mesh 47 may comprise a heavy steel grid, or other material to reduce interference with radio waves emitted by the storage kiosk 10.

The lid 46 preferably supports several cameras 48 that record persons approaching the storage kiosk 10. In one preferred embodiment, three to six cameras 48, each having a wide angle lens, are installed on the lid 46 inside separate camera housings 50. The cameras are preferably connected to the CPU 34 at all times and keep a real-time photographic record of employees installing a cell phone 22 in a storage compartment 20, receiving a smart watch 38 from a dispensing compartment 24, and retrieving the cell phone 22 throughout the day. The images generated by the cameras 48 are preferably stored on a memory in the CPU 34. In other embodiments, the cameras 48 may record continuously, or may be set to record based on motion in front of the kiosk 10. As space is needed for new imagery, older files may be deleted, and in the preferred embodiment, only authorized storage kiosk 10 technicians will have access to the photographic data produced by the cameras 48 to assist an employer or law enforcement in the event of damage or theft.

For security, the locker portion 14 of the storage kiosk 10 preferably includes one or more sensors that alert all dispensed smart watches when someone attempts to gain access to the CPU 34 or any other predetermined area of the storage kiosk 10. Additionally, the CPU 34 preferably includes a GPS locator built into it and although it may not be connected to the Internet (for privacy reasons), it will reflect that the storage kiosk 10 has been moved and alert all issued smart watches upon sensing movement.

Although contemplated embodiments may be designed to draw electricity using existing wiring, however, the preferred embodiment storage kiosk 10 should be erected outdoors and powered exclusively by sunlight that gradually charges internal long-life batteries 52, preferably stored in the locker portion 14. In the event of insufficient battery 52 power, the storage kiosk 10 should be programmed to send a timely alert to all outstanding smart watches indicating that the batteries 52 are low and that the employees should retrieve their cell phones 22 promptly. Because the storage kiosk 10 is installed in an outdoor location, an umbrella-like accessory (not shown) may be provided that securely attaches to the top of the pole. This accessory will attach directly beneath the solar power panel connection. Preferably the “umbrella” feature will be made of a transparent material, to allow in as much light as possible, for safety reasons. Optionally, it may be configured to be ringed with dusk-to-dawn LED lighting for night-time safety as well.

The structure of the secure phone storage with alert mechanism having been shown and described, its method of operation will now be discussed. Two installation types are contemplated for the invention; a stand-alone version, where the storage kiosk operates in isolation, and a networked version, where the storage kiosk is installed as part of a larger employer data system. Three phases of use are contemplated; an installation and setup process, an employee registration (i.e., ‘onboarding’) process, and day-to-day use of the storage kiosk.

In the installation and setup process for the stand-alone version, an employer, or other responsible party procures a storage kiosk through purchase or lease, according to a standard telephonic, online, or in-person ordering process. Preferably the organization offering the storage kiosk provides the purchaser/lessee guidance as necessary regarding the number of storage kiosks needed for a specified number of employees to be assigned a storage compartment, and the capacity of each different model ordered. Before purchase, the employer is provided specific guidance as to where to site the storage kiosk on a property. If the employer has any doubts as to the position of the storage kiosk, a representative from the provider may need to perform a site visit to confirm the feasibility of a chosen location.

If the locations are acceptable, upon purchase or lease an authorized storage kiosk installation crew is scheduled to go to the employer's preferred location, excavate a hole and bury a special connecting plate (not shown) at the selected site(s). Conversely, an outside contractor may be hired by the employer to install the connecting plate following written instructions. The connecting plate may be a pre-made part available from industrial piping suppliers or existing lighting post vendors. Either the storage kiosk installation crew or a hired contractor will then be pour concrete around the plate and only the topmost portion with threaded studs will be visible. Once the concrete has cured sufficiently, photographic confirmation will occur and a delivery will be scheduled for the storage kiosk itself. Coordination with local mini-crane operators is envisioned, however an alternative would be a custom-built tilt-up machine that can be present on-site at the same time as the Phone Pole(s) arrive and used to erect the poles.

Upon installation of the connecting plate, heavy gauge threaded bolts will protrude from the connecting plate and are used to align with and hold the storage kiosk in position. Large nuts will be threaded onto the studs and tightened. The two segments can then be spot-welded together if the employer desires added permanency to the installation. After the storage kiosk is connected to the plate, employees can register with the system by downloading the associated phone app which will guide them through the process. A data port (not shown) in an inconspicuous section of the storage kiosk allows an employer to conduct for periodic non-private data retrieval by authorized individuals. Along with the data port, an emergency power port may also be provided as necessary.

During the employee registration phase, which may be upon an individual employee being hired or after the initial installation of the storage kiosk, an employee is directed to download and install a platform agnostic software application to the employee's phone. The software preferably takes the form of an app available from an ‘app store’ associated with the employee's phone type. When launched, the app instructs the employee to set up a unique identity profile, which may include various authentication schemes such as a personal identification number, fingerprint, voice impression, challenge question(s), facial recognition photography and/or retina scanning, among others. The profile authentication information is stored only on the storage kiosk and is preferably never relayed to any external storage source.

Because the storage kiosk does not rely on any external input, if an employee's cell phone is lost or stolen outside of the work setting, the user must create a new profile and re-register as would a new employee. Once a profile has been established and authenticated, the app instructs the employee to physically connect the employee's cell phone to the storage kiosk via a special on-boarding cable stored in a secure part of the locker portion. Preferably the app displays a picture of how to locate the on-boarding cable, which provides a first-time link to the CPU. The CPU then automatically downloads the authentication information of the employee and creates a new user profile. The storage kiosk then assigns an available storage compartment and the door to the storage compartment unlocks automatically.

The app instructs the employee to disconnect the cell phone from the on-boarding cable and to physically re-connect the phone to the cable residing in the assigned storage compartment. Once the CPU confirms that the cell phone is properly connected to the inner cable, and that both data and electrical charge functions are working, the CPU creates a digital pairing between the employee's cell phone (and app) and the smart watch located in the locked dispensing compartment associated with the employee's cell phone's storage compartment. A one-time indicator, such as a flashing green light at the authentication area will indicate to the employee that the initial authentication procedure must take place in order to proceed.

The employee authenticates the employee's identity for the first time, and once confirmed, the CPU actuates the drawer release mechanism, which opens under its own weight to allow access to the smart watch in the dispensing compartment. The smart watch in the dispensing compartment is preferably a fully-charged RF-capable device. Although it is directly paired only to the storage kiosk, the CPU is authorized to be the sole relay for the designated authenticated cell phone occupying the corresponding storage compartment.

Once the employee removes the smart watch from the post on the drawer in the dispensing compartment, the storage kiosk provides an automatic and persistent visual alert reminding the employee to close the charging dispensing compartment completely. Once the dispensing compartment is closed, the alert ends, and a brief alert on the smart watch indicates that the cell phone is secure, connected, and that the employee may commence work. Throughout the day, any appropriate notifications, such as texts and missed calls that are received by the cell phone are “pushed” by the app to the CPU, which transmits them to the smart watch, and therefore, the employee as well. Any cell phone notifications not authorized by the app are filtered out.

If an employer wishes to change the default settings of the Phone Pole App such that an employee can receive emails, news alerts, or other information in addition to texts and missed call alerts, the employer can instruct the employee in question to open the storage kiosk app and select indicators, preferably on a ‘settings’ screen. For example, the employee may check boxes in a settings panel corresponding to “also relay emails” and/or “also relay emergency news alerts.” When these selections are made, the CPU will route these additional types of notifications until unchecked in the app.

When an employee needs to return to the storage kiosk to retrieve a cell phone, the employee approaches the storage kiosk and while standing in front of the appropriate storage compartment, the employee initiates the authentication process by engaging the authenticator to provide the employee's identity. Once the authenticator confirms the correct authentication information from employee (such as fingerprint, numerical code, etc.), the authenticator notifies the CPU which cases the storage kiosk to release the bottom drawer, which swings open to accept the employee's smart watch.

The smart watch buzzes and presents an instruction directing the employee to place the smart watch in the drawer for charging. The employee must place the smart watch on the central post inside the drawer in order to ensure that the charging contacts will effectively transmit current to the device. The weight of the smart watch, along with a magnetic connection, will ensure that the smart watch makes contact with the charging contacts properly. The user then manually closes the drawer.

Upon the employee closing the drawer, the CPU will run a diagnostic check to determine that the smart watch is properly charging, and that the drawer has been fully closed. If both conditions are satisfied, the CPU will cause the storage kiosk to release the lock on the door of the main (Smartphone) compartment, and the user will be free to disconnect their phone and depart.

If a storage compartment or dispensing compartment is not closed, a red LED light mounted on or near the open door will preferably flash with increasing intensity, and upon the expiration of a predetermined time, an audible sound will issue from the locker portion to encourage anyone walking by to close the door. If damage occurs to the cable that is inside the storage compartment due to negligence on the employee's part (i.e. by not closing the door), the CPU will have both a timestamp and photographic evidence to assign fault.

During the day-to-day use phase, in a preferred embodiment, the secure phone storage kiosk is used in the customary manner as follows: 1. The employee arrives at designated storage compartment and activates the authentication process by interacting with the authenticator. 2. The CPU authenticates and grants access to a predetermined storage compartment. 3. The employee physically connects the data/charging cable inside the storage compartment to the employee's cell phone, and then fully closes the storage compartment door. 4. The CPU confirms the that a data/charging link is established with the cell phone and that the door is properly closed, locks the storage compartment and unlocks dispensing compartment revealing a fully-charged wearable smart watch (or other similar wearable device) in a drawer. 5. The employee retrieves the smart watch from the drawer and closes the dispensing compartment, which is locked by the CPU when closed. 6. The employee proceeds through the work day, receiving missed call and text alerts as they come in, but not receiving other notifications. 7. The employee then returns to the designated storage and dispensing compartments and activates the authenticator via a predetermined authentication step. 8. The CPU releases the lock to the dispensing compartment, which opens allowing the drawer to swing out. 9. The employee inserts the smart watch onto the post, making sure it properly connects to the charger, and closes the door to the dispensing compartment. 10. The CPU verifies that the smart watch is properly registered and charging, and releases the lock on the storage compartment, allowing the employee to disconnect and extract the employee's cell phone. 11. The employee is then reminded to close the storage compartment door, for example by a persistent flashing lights and/or sound if the door is not properly closed after a predetermined time interval.

A storage kiosk in a non-stand-alone configuration is similar in installation and operation, with the following differences: Once one or more storage kiosks have been fully installed, an additional piece of radio/electronic hardware is connected to a designated computer (or computer network) using a communications device. The communications device includes a radio or similar transmission functionality located in such way as to be in good radio contact with all storage kiosks on the premises (or those designated for management). At user-defined predetermined intervals, the storage kiosks package collected data and send the data via radio frequency to the communication device. The communication device will then communicate to an associated employer computer (or network) via user-installable software. Using the software, which may be customized according to user preference, an employer will have visual access to all logs created by the various storage kiosks.

A storage kiosk technician performs the initial pairing of storage kiosks and communication devices, and afterward the employer is able to be in constant communication with the storage kiosks, and is able to control them. For example, the employer may be able to change settings from the PC software instead of having to access each storage kiosk. The data from the storage kiosks(s) can also be integrated into existing time-keeping, time-card, and accounting applications, or conversely, proprietary software may be purchased to achieve a company's payroll and accounting goals with a single application. In the non-stand-alone configuration, the authentication data preferably remains private between the installed app and the storage kiosk CPU.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A secure mobile phone storage and wristband dispensing apparatus for securely storing mobile phones, the apparatus comprising:
a support portion coupled to a locker portion;
the locker portion comprising a plurality of storage compartments, a plurality of dispensing compartments and at least one authenticator;
each of the plurality of storage compartments comprising a charging station;
a plurality of electronic wristbands individually stored in each of the plurality of dispensing compartments; and
a processor in communication with the locker portion, wherein the processor is configured to unlock one of the plurality of dispensing compartments upon successful connection of a mobile phone to the charging station, and configured to unlock one of the plurality of storage compartments upon re-installation of one of the plurality of electronic wristbands in one of the plurality of the storage compartments and successful authentication by the at least one authenticator.

2. The apparatus of claim 1 wherein the support portion comprises a vertical tower.

3. The apparatus of claim 1 wherein the support portion comprises a widened base having a securing mechanism for securing the support portion to a surface.

4. The apparatus of claim 1 wherein the locker portion is comprises a cylindrical shape.

5. The apparatus of claim 1 wherein each of the plurality of storage compartments is adjacent an associated dispensing compartment.

6. The apparatus of claim 1 wherein each of the plurality of dispensing compartments is located underneath an individual storage compartment.

7. The apparatus of claim 1 wherein the plurality of storage compartments comprises between twenty and forty storage compartments.

8. The apparatus of claim 1 wherein the support portion includes a solar array configured to charge stored mobile phones.

9. The apparatus of claim 1 wherein the support portion comprises a GPS transponder.

10. The apparatus of claim 1 wherein the charging station comprises a universal mobile phone connector.

11. The apparatus of claim 1 wherein each of the plurality of dispensing compartments comprises a connector post for holding and charging the electronic wristband.

12. A secure mobile phone storage and wristband dispensing apparatus for securely storing a mobile phone, the apparatus comprising:
a support portion coupled to a locker portion;
the locker portion comprising a plurality of storage compartments, a plurality of dispensing compartments and at least one authenticator;
each of the plurality of storage compartments comprising a charging station;
a plurality of electronic wristbands individually stored in each of the plurality of dispensing compartments;
at least one camera arranged to provide a surrounding view of an area surrounding the locker portion, and
a processor in communication with the locker portion, wherein the processor is configured to unlock one of the plurality of dispensing compartments upon successful connection of the mobile phone to the charging station and configured to unlock one of the plurality of storage compartments upon installation of one of the plurality of electronic wristbands in one of the plurality of the storage compartments and successful authentication by the at least one authenticator.

13. The apparatus of claim 12 wherein the authenticator comprises a fingerprint scanner.

14. The apparatus of claim 12 wherein the processor is configured to issue a single power outage warning collectively to the plurality of wristbands.

15. The apparatus of claim 12 wherein the processor is configured to issue a low battery power warning independently to a selected number of the plurality of wristbands.

16. The apparatus of claim 12, wherein the processor is configured to convey messages from the mobile phone stored in one of the plurality of storage compartments to one of the plurality of electronic wristbands outside locker portion.

17. A method of securely storing a mobile phone and issuing an electronic wristband in exchange for storing the stored mobile phones, the method comprising the steps of:
providing a locker portion in a mobile phone storage apparatus;
providing a storage compartment within the locker,
providing a dispensing compartment within the locker;
activating an authentication process by interacting with an authenticator,
unlocking the storage compartment, opening the storage compartment and connecting a mobile phone to a connector in the storage compartment;
closing the storage compartment; and
unlocking the dispensing compartment, opening the dispensing compartment and removing an electronic wristband.

18. The method of claim 17 further comprising the step of transmitting a message received by the mobile phone to the electronic wristband outside the locker portion.

19. The method of claim 17 further comprising the step of providing a fingerprint authenticator associated with the storage compartment and the dispensing compartment.

20. The method of step 19 further comprising the step of unlocking the storage compartment upon authentication and reinstalling the electronic wristband in the dispensing compartment.
